(19) United States
(12) Patent Application Publication
(10) Pub. No.: US 2005/0288397 A1
(43) Pub. Date: Dec. 29, 2005

(54) Viscous materials and method for producing

(76) Inventor: Matthew Piazza, Oceanridge, FL (US)

Correspondence Address: JACKIE JAY SCHWARTZ, 1350 Broadway, Suite 1510, NEW YORK, NY, 10018, US

(21) Appl. No.: 11/170,769

(22) Filed: Jun. 29, 2005

Related U.S. Application Data
(60) Provisional application No. 60/583,672, filed on Jun. 29, 2004.

(51) Int. Cl. C08K 3/00; B65D 25/08

(52) U.S. Cl. 524/2; 206/219

(57) ABSTRACT

A method for minimizing reactions between a plurality of reactionary chemicals comprising the activities of adding a first chemical and adding a first barrier layer, the first barrier layer resting atop the first chemical. Thereafter, adding a second chemical, the second chemical resting atop first barrier layer. A second barrier layer is added whereby, the second barrier layer rests atop the second chemical. A further chemical is added wherein the further chemical resting atop the second barrier layer. The chemicals and barrier layers are mixed uniformly, thereby evenly distributing each of the first, second and further chemical to form a mixture wherein the chemicals are added in order of decreasing density.

### CROSS REFERENCE TO RELATED APPLICATION

This is a non-provisional application of provisional application Ser. No. 60/583,672 by Matthew Piazza filed on Jun. 29, 2004.

### FIELD OF THE INVENTION

The present invention relates generally to building materials and, more specifically, to composition for producing building materials and a method for producing the composition.

### BACKGROUND OF THE INVENTION

### Description of the Prior Art

Present day cemetitious building materials are heavy and have limited strength. These materials are generally produced using vermiculite and/or other fibrous lightweight materials, water and cement. In order to produce these building materials, a large amount of water is required as the vermiculite and other fibrous lightweight materials are very absorbent and able to absorb tremendous amounts of water used to produce building materials. The water absorbed by the vermiculite and other fibrous lightweight materials is needed to wet and strengthen the cement. The use of water in the cemetitious building materials adds to the weight of the building material and although used to create the building material causes stress fractures to form within the cemetitious building material upon freezing and thawing.

It is thus desirable to produce a composition which is able to reduce the amount of water needed to produce building materials. It is also desirable to produce an admixture able to be added to cement with vermiculite and other fibrous lightweight materials produce a building material including a minimal amount of water. It is further desirable to produce a building material wherein a liquid or gel wetting agent is added to saturate the vermiculite and other fibrous lightweight materials used in the material thereby obviating the need to use water. It is further desirable to combine certain reactive elements in a manner able to minimize or eliminate any reaction occurring therebetween for addition to the building material.

### SUMMARY OF THE PRESENT INVENTION

The present invention relates generally to building materials and, more specifically, to composition for producing building materials and a method for producing the composition. The composition includes a plurality of chemicals that are normally undesireably reactive with one another.

It is a primary object of the present invention to produce a viscous composition for producing a building material which overcomes the limitations of prior art building materials.

It is a further object of the present invention to produce a viscous material that is formed by combining an admixture with at least one of cementitious materials, rubbers, plastics.

Another object of the present invention is to produce a viscous material wherein the admixture includes certain reactive elements in a manner to reduce or eliminate the reaction therebetween.

It is a still further object of the present invention to produce a viscous material wherein the admixture is able to increase the strength and reduce the weight of the resulting building material.

A yet further object of the present invention to produce a viscous material wherein the properties associated with each element of the admixture are imparted to the resulting building material.

Still another object of the present invention is to produce a building material including at least one of nanoparticles and nanotubuoles for providing additional attributes to the resulting building material.

A further object of the present invention is to provide a method for minimizing reactions between a plurality of reactionary chemicals. The method includes the the activities of adding a first chemical and adding a first barrier layer, the first barrier layer resting atop the first chemical. A second chemical is added and the second chemical rests atop the first barrier layer. A second barrier layer is added which rests atop the second chemical. A further chemical is added and the further chemical composition rests atop the second barrier layer. The chemicals and the barrier layers are mixed uniformly, thereby evenly distributing each of the first, second and further chemical to form a mixture wherein the chemicals are added in order of decreasing density.

Another object of the present invention is to provide a composition comprising a first chemical, a second chemical; and at least one barrier layer positioned between the first chemical and the second chemical for preventing interaction therebetween. Upon mixing the composition according to predetermined rules to a mixture having each of said first chemical and second chemical uniformly distributed throughout is produced.

Yet another object of the present invention is to provide a composition comprising at least one of a substrate and casting material and an admixture. The admixture includes superplasterizer, self-consolidator, shrinkage reducers and a plurality of barrier layers. When producing the admixture one of the plurality of barrier layers is provided between each adjacent element of the admixture preventing intermixing between the elements thereby minimizing reactions between the elements and allowing each respective element to maintain properties associated therewith. When said admixture is combined with the substrate and mixed to form the composition the admixture is uniformly distributed throughout the composition causing the at least one of substrate and casting material and each element of the admixture to bond to each other.

An even further object of the present invention is to provide a method for producing a composition. The method includes combining a predetermined amount of at least one of a substrate and a casting material with at least one of water and a wetting agent in order to saturate the at least one of the substrate and casting material. Thereafter, combining an admixture with the saturated substrate and casting material. The admixture includes superplasterizer, self-consolidator, shrinkage reducers and a plurality of barrier layers. One of the plurality of barrier layers is provided between each element of the admixture preventing intermixing between the elements thereby allowing each respective element to maintain properties associated therewith. The method provides for continuously mixing the mixture of at least one of substrate and casting material and admixture and forming a composition wherein each respective element of the admixture is uniformly distributed throughout the composition causing the elements of the admixture to bond with each of the at least one of substrate and casting material and having properties associated with the elements of the admixture.

Another object of the present invention is to produce an admixture and building material that is simple and easy to use.

A still further object of the present invention is to produce a building material that is economical in cost to manufacture.

Additional objects of the present invention will appear as the description proceeds.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a flow chart illustrating the process for producing the admixture;

FIG. 2 is a cross-sectional view showing a vat showing layering of the elements forming the admixture prior to mixing;

FIG. 3 is a flow diagram showing the process for producing a building material including the admixture;

FIG. 4 is a perspective view of a static mixer used to mix the elements forming the building material;

FIG. 5 is a flowchart illustrating the process of producing an alternate embodiment of the admixture of the present invention; and

FIG. 6 is a cross-sectional showing the layering of an alternate embodiment of the admixture.

### DETAILED DESCRIPTION OF THE PREFERRED EMBODIMENT

The present invention describes a chemical admixture for producing a material that is able to be used as a building and construction material. The resulting material is able to be used for ornamental decoration as well as for structural support of a structure. Thus, the chemical admixture can be used with at least one of a cement-based material, a plastic material and a rubber material and upon using the admixture, the resulting material has improved properties that up until now we not able to be realized. The resulting material therefore includes the admixture, vermiculite and a substrate for casting the material in a desired form. Thus, the following description of a cement-based building material is not to be considered limiting as the admixture can be used in additional areas with additional benefits which will be pointed out throughout the following description.

When producing a building material including cement and vermiculite and/or fibrous lightweight materials, the vermiculite or lightweight materials should be placed into mixture first before the addition of water. The chemistry or admixture of the present invention doesn't react with lightweight materials. The admixture will only react with cemetitious materials, therefore when making a lightweight mix with this material the vermiculite must first be wet out with water.

The present invention is a process of mixing elements that normally react with one another in a nondesirable way and conventional wisdom indicates should not be mixed together. This method was discovered when putting a liquid or gel directly into the vermiculite or lightweight raw materials in the mix.

The method for mixing the elements together that would normally react on contact concerns elements which are normally used in producing building materials, especially cemetitious building materials. This method may also be used in mixing other such chemicals that would normally react on contact with each other.

The elements used in the method of the present invention to produce the inventive admixture include:
Carboxylated Polyther such as Superplasterizerolymer;
Carboxylated Propylene such as a Self consolidator; and
Aliphatic Propylene, Glycolethers such as Shrinkage Reducers.
Surfactant, preferably non-ionic surfactant

Additional elements added to the admixture may include:
Water Reducing agents—Aqueous solution of Carboxylated Polyther, Calcium, Nitrate and Amines Glycose;
Viscosity Control agent for reducing segregation;
Shrinkage control agents;
Water—repellant agents; and
Air-entraining agent
   Further elements added to the admixture include:
nanoparticles formed from a silicon based oxide
nanotubuoles formed from a silicon based oxide
latexes
at least one of yttrium Oxide, aluminum oxide, aluminum silicon oxide, barium silicon oxide, barium zirconium oxide, cerium oxide, magnesium oxide and zirconium oxides

All of the above are not brand names but are defined by their function when placed in the cement mixture individually.

There are drawbacks associated with producing a building material with the above admixture along with cement and vermiculite. Specifically, the vermiculite will absorb a significant quantity of water. Twenty (20) pounds of vermiculite will absorb up to 5 gallons of water and result in a composition having the consistency of wet sand. Therefore, it is not desirable to add the admixture directly to the vermiculite because the vermiculite will absorb the components of the admixture and thereby prevent uniform distribution within the mix containing the cementious materials. The admixture is added to the mix of cement with additional water. The use of the admixture substantially reduces the amount of and potentially eliminates the need for water to be added to produce the building material. Additionally, matakatolin, a lightweight fiber may be added to the composition for strengthening the resultant building material.

Alternatively, in place of water, a liquid or gel wetting agent may be added to the vermiculite to thereby wet out the vermiculite with no water. Due to the properties of known wetting agents, a substantially smaller amount of wetting agent is necessary to saturate the vermiculite or and fibrous lightweight materials to produce the composition. Additionally, known wetting agents weigh much less than water and thus reduce the weight of the saturated vermiculite or and fibrous lightweight materials. Furthermore, the liquid or gel wetting agent may be mixed in the admixture used when mixing any material which may be needed to react the product. The liquid or gel wetting agent may be used to form layers between the reactive elements of the admixture thereby reducing the amount of water and thus reducing the weight of any product produced using the admixture.

Therefore, as will discussed hereinafter, the building material produced by the composition of the present invention allows for typically reactive chemical elements to be combined by an inventive layering process which prevents any interaction therebetween. The composition is formed by using an admixture wherein a layer of one of water and liquid or gel wetting agent is formed above a heaviest one of the chemical elements prior to addition of the next heaviest of the elements thereby preventing a reaction from occurring therebetween. Thus, as the combination of chemicals continues, a layer of one of water and liquid or gel wetting agent is formed between a previous and subsequent element added to the admixture.

In place of water, a liquid or gel wetting agent may be added to the vermiculite to thereby wet out the vermiculite with no water. Due to the properties of known wetting agents, a substantially smaller amount of wetting agent is necessary to saturate the vermiculite or and fibrous lightweight materials. Additionally, known wetting agents weigh much less than water and thus reduce the weight of the saturated vermiculite or and fibrous lightweight materials. Furthermore, the liquid or gel wetting agent may be mixed in the admixture used when mixing any material which may be needed to react the product. The liquid or gel wetting agent may be used to form layers between the reactive elements of the admixture thereby reducing the amount of water and thus reducing the weight of any product produced using the admixture.

Also, a liquid or gel wetting agent may be added to cement instead of water in order to make cemetitious material without water. The cemetitious material produced will have the characteristics of the finished product as if you mixed with water. Because of the elimination of water the cemetitious materials will be stronger than the conventional concrete mix.

A preferred wetting agent for use in preparing the admixture is a non-ionic surfactant. A surfactant is a compound having a hydrophilic section and a hydrophobic section. The chemistry of a surfactant allows the substance to reduce the surface tension of the system, thereby allowing the surfactant to be used as a wetting agent. The hydrophilic segment of a surfactant are judged by the number of moles of Ethylene Oxide. Ethylene Oxide chains form the hydrophilic portion of the surfactant molecule. The larger this portion of the molecule, the more water soluble is the non-ionic surfactant. Additionally, surfactants, and their functionality, are judged using an arbitrary scale that depicts its Hydrophilic/Lipophilic Balance (HLB). A low HLB value signifies a more oil soluble surfactant whereas a higher HLB represents a surfactant with good water solubility. The HLB value is a numerical value that is calculated based on the molecular structure of the surfactant. Ideally, the non-ionic surfactants have an HLB value ranging between 7-9.

Preferably, the non-ionic surfactant is an Octyl Phenol Ethoxylate which is produced by the addition of ethylene oxide to Octyl phenol. The resultant Octyl Phenol Ethoxylate is effective over a wide temperature and pH range and forms strong gels and viscous solutions that are used as low foaming wetting agents in agriculture applications. However, their chemistry is such that it allows for use in the admixture of the present invention. The non-ionic surfactant is positioned between the layers of additional materials such as the plasterizers and shrinkage control agents to prevent the normal, but unwanted interaction therebetween. When added, the surfactant acts as a barrier layer between sequentially added components of the admixture. The surfactant is combined into the admixture when all the added components are mixed together.

Alternatively, layers of latex can be added to the admixture in place of the non-ionic surfactant. Similarly to the surfactant, the layers of latex are positioned between the sequentially added components of the admixture and act as barrier layers preventing any premature and/or unwanted reaction between components. The latex functions as a carrying agent which helps disperse the various components upon being mixed together. The latex also acts as a wetting agent thereby replace water which is typically used in prior art building and architectural materials.

An additional strengthening component to be added to the admixture is a silicon based oxide. Silicon based oxides are excellent additives that function as hardening enhancing agents. Additionally, silicon based oxides are used to increase the scratch-resistance of a compound. Based on the improvement of hardness and scratch resistance, silicates have a specific usefulness as an additive in bricks and building materials.

It is preferable that the silicon based oxide to be added to the admixture be in the form of either nanoparticles or nanotubuoles, such as PURENANO® which is produced by NanoProducts Corporation. The nanoparticles of these silicon based oxides provide non-agglomerated nanoscale materials that are able to be homogenously distributed into a mixture, such as in the admixture of the present claimed invention. The enhancing features of the nanoparticles are the result of their formation. Specifically, the combination of the silica, at the lattice level, with one or more metals allows for the modification of the mechanical, optical, thermal, surface, structural and other properties. Thus, the nanoparticles of silicon based oxide can be tailor-made specifically for use in the admixture of the present invention. Examples of various silicon based oxides that can be used are Aluminum Silicon Oxides, Zirconium Silicon Oxides, and other multi-metal silicon oxides.

### HOW TO PREPARE THE ADMIXTURE

### EXAMPLE: A FIVE GALLON MIX

Pouring superplastesizer mix into a five gallon pale using normal tap water and pouring enough water to put approximately an eighth of an inch water/surfactant barrier layer on top of the superplastesizer. The layer of water/surfactant layer acts a barrier as the water/surfactant is lighter than the superplastesizer and remains on top of the superplastesizer. When pouring the next element, e.g. a self-consolidator (or self-compactor), onto the top of the water/surfactant layer it will not flash or create a chemical reaction. The process is then repeated by placing a layer of substantially the same amount of water/surfactant atop the second layer and adding a third element, e.g. a shrinkage control agent. This process is then repeated for each additional element to be added to the admixture.

In the above exemplary admixture, there is substantially 1¼ gallons of superplasterizer, substantially 2.5 gallons of self consolidator and substantially ¾ gallon of shrinkage control agent. The admixture described above further contains substantially ½ gallon of the water/surfactant barrier layer which is interspersed between each of the the layers of superplasterizer, self-consolidator and shrinkage control agent. Furthermore, as described above, each respective water/surfactant barrier layer is present in substantially equal amounts.

The above was created for an admixture with many attributes to be added to cemetitious products. This same method may be used for other chemical admixes. The method described above may be used to produce admixtures useful for many different purposes including elements which normally react with one another. The use of the above described admixture is for purposes of example only and not meant to limit the method of the present claimed invention.

Alternatively, the admixture in place of the water/surfactant barrier layer, at least one of a water, a liquid wetting agent, a gel wetting agent and a gel-form wetting agent may be positioned between each adjacent layer of chemical additives.

When making a lightweight concrete mixture raw materials such as vermiculite, purlite, micra, etc are normally combined with cement. However, use of these raw materials is problematic as the these lightweight materials are highly water absorbent. The mixture will thus require a large amount of water in order to function as desired. Mixing large amounts of water with cement diminishes the strength of the cement as well as increases the weight of the resulting concrete product. The admixture of the present invention functions to reduce the amount of water necessary thereby increasing the strength of the resulting building material as well as decreasing the weight thereof. An exemplary formulation of the admixture of the present invention is shown below as Formulation A.

### Formulation A

2 parts Carboxylated Polyther such as Superplasterizerolymer;
1 part Carboxylated Propylene such as a Self consolidator;
1 part Aliphatic Propylene, Glycolethers such as Shrinkage Reducers; and
1 part surfactant

In addition to the elements listed in Formulation A, other additional chemicals may be included in the admixture to confer additional properties thereon. These additional elements include at least one part air-entrainers, one part nanoparticles of a silicon based oxide and one part latex. The description of nanoparticles being formed as a silicon based oxide is for purposes of example only and any type of nanoparticles having desirable properties associated therewith can be utilized with the admixture and/or viscous material of the present invention.

The chemicals listed above are layered in a mixing vat and include a layer of water and/or wetting agent between adjacent layers. This layer prevents the unwanted and undesirable interaction between the component elements of the admixture of the present invention.

Alternatively, the mixture can utilize a plurality of parts of latex as a carrying/wetting agent which is positioned between each respective component identified above. Thus, the latex can be a one of the layered components of the admixture or it can be used as a barrier layer between the sequentially added components thereof.

Also, the nanoparticles formed from silicon based oxide can be their own respective sequentially added layer positioned between two layers of wetting agent. Alternatively, the nanoparticles can be combined with another one of the sequentially added component layers identified above. Additionally, the nanoparticles can be injected into the mixture and/or composition immediately prior to or during the casting process. The nanoparticles have at least one predetermined attribute to be added to the composition for use in producing a building material. These attributes include but are not limited to increased strength, increased durability, reduced thermal expansion, color augmentation, and increased hardness.

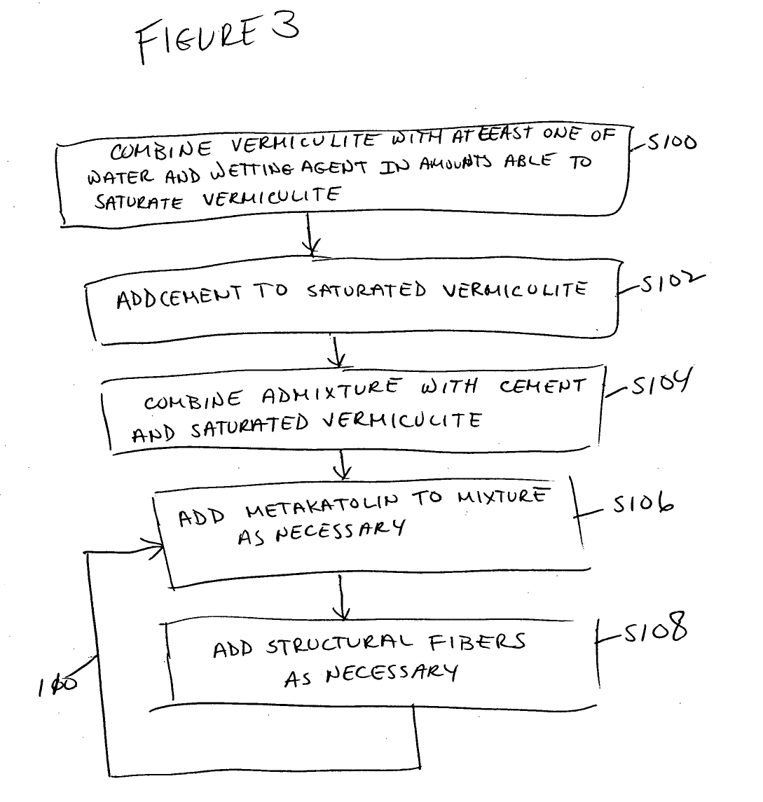

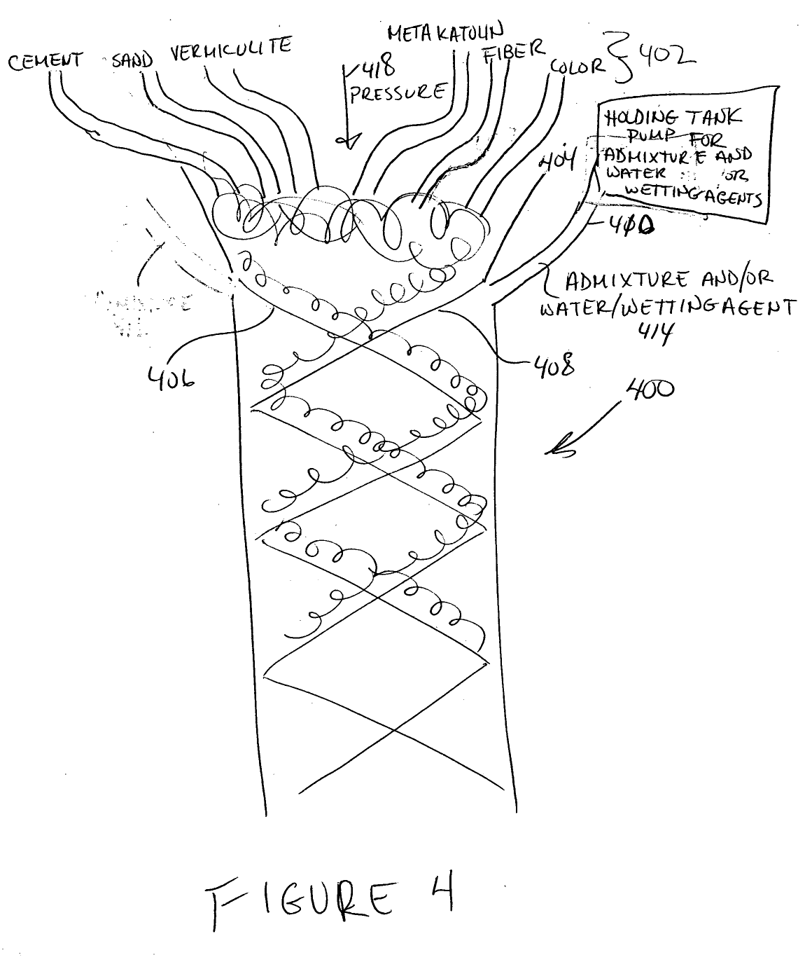

The building material of the present invention is produced when the above admixture is combined in the inventive method discussed hereinafter with specific reference to FIGS. 3 and 4. Upon mixing, a finished castable cemetitious mix is produced that has all the attributes of concrete and none of the drawbacks. The resultant building material has a substantially reduced weight, increased flexibility, and increased tensile strength which can be more than four times that of conventional concrete. For example, conventional concrete will generally have up to 200 lbs. tensile and flexible strength while the building material of the present invention will have 650 to 850 lbs. tensile and flexible strength.

The building material of the present invention includes a combination of raw materials as shown in Table 1 below. These raw materials are generally dry powdered materials and are combined with the admixture discussed above as Formulation A. to produce the building material.

TABLE 1
Raw Materials

Cement
Sand or Silica
Metakatolin- apozzo-lanie-material
Vermiculite or substitutes- purlite, mica, ect.
Fiber
Polypropylene
Polyethelene
Fiber glass or any other fibrous material
at least one of nanotubes and nanopowders

The amounts of the above raw materials used to produce the building material of the present invention may vary depending on the needs of the user.

In order to produce the building material of the present invention, an exemplary combination of certain raw materials from Table 1 with Formulation A will be discussed hereinbelow as Formulation B. Formulation B includes:

### Formulation B

1 bag of cement—approx 94 pounds
50 lbs of sand
20 lbs of vermiculite
5 lbs of metakatolin
1 quarter pound of polypropylene microfiber
1 lb of polypropylene structural fiber
1 quart of Admixture of Formulation A
8 gallons of water

The above raw materials in combination with the admixture of Formulation A produces a complete stable monolithic viscous cementitous mix which can be used to form a plurality of different cementitious products. The resulting building material is a concrete material that has an increased tensile and flexile strength and a decreased weight.

Additionally, the strength of the produced cementitious materials can be increased and the weight reduced by eliminating the addition of water to the mix by replacing the water with a liquid or gel wetting agent normally used in the agricultural field to wet grounds. This will also eliminate the problem of over wetting the cement, and thus produce a much more stable homogenous mix. Furthermore, when using a lightweight material such as vermiculite in the cemetitious mix that has absorbing qualities, moisture trapped within the lightweight material is released over time into cemetitious material strengthening the cemetitious material continuously over a longer period than a normal conventional concrete because of this the hydration of cemetitious materials is stabilized to allow the material to cure constantly and also to cure stronger.

The above described admixture and methods may also be used to mix grouts, stuccos and any other cement mix.

Furthermore, the above mixing technique can be used in conjunction with forming rubber and plastic material. For example, a viscous composition formed from acetate, PVC, polyethylene fibers and polypropylene fibers can be produced using a gel emulsion barrier layer positioned between each respective element added during the mixing process. This prevents the reaction between the elements prior to uniform mixing thereof. Additionally, at least one of nanoparticles, nanopowders and nanotubuoles as described hereinabove may also be added to the mixture in the described manner.

The attached figures will now be discussed to show and describe the inventive methods presented herein and the inventive compositions produced using the inventive methods.

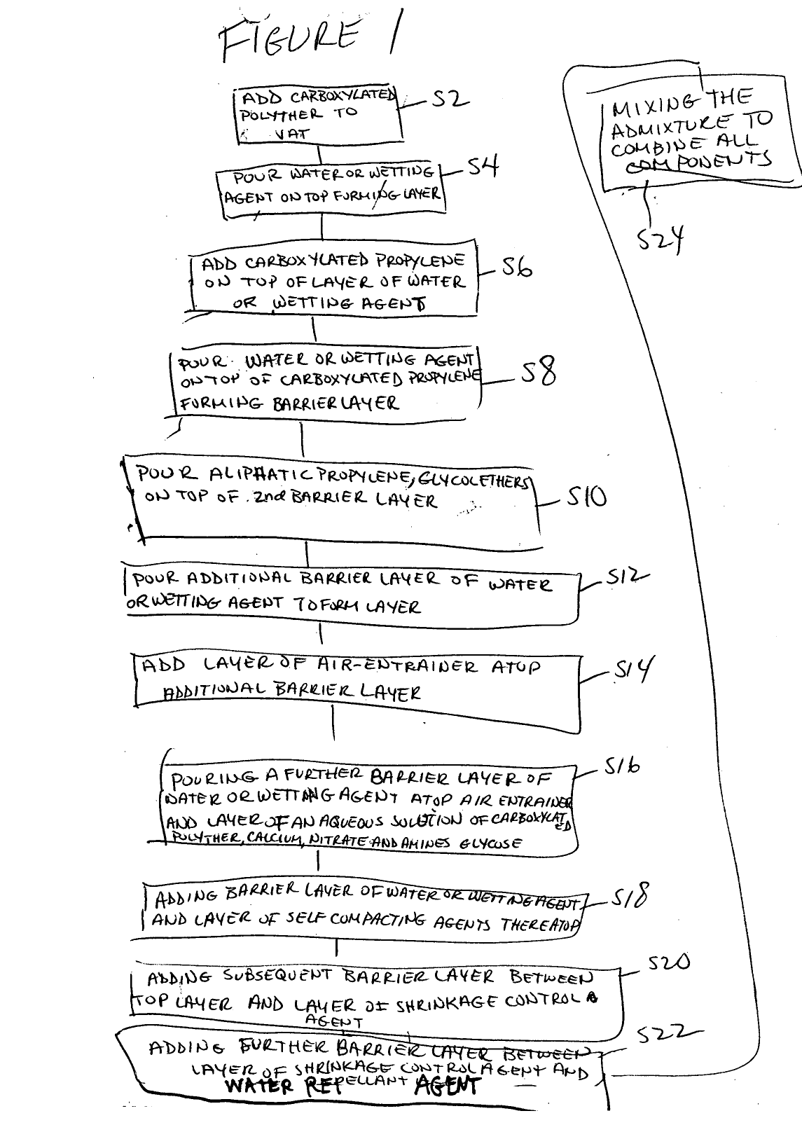

FIG. 1 is a flow chart illustrating the method for producing the inventive admixture or producing a mixture formed from elements which normally would react with one another. As can be seen from this figure, the admixture is formed by adding a predetermined amount of Carboxylated Polyther such as a Superplasterizer as discussed in step S2. Next, a layer of at least one of water, liquid wetting agent or gel wetting agent is placed atop the superplasticizer forming a barrier layer thereon as stated in step S4. Atop the layer of at least one of water, liquid wetting agent or gel wetting agent, a layer of Carboxylated Propylene such as a Self consolidator is positioned as described in step S6. Normally, when a Carboxylated Polyther is combined with a Carboxylated Propylene, a chemical reaction is produced such as foaming. However, the positioning of the barrier layer of at least one of water, liquid wetting agent or gel wetting agent therebetween minimizes or eliminates any reaction between the Carboxylated Polyther and Carboxylated PropyleneA. Another barrier layer of at least one of water, liquid wetting agent or gel wetting agent may then be positioned atop the layer of Carboxylated Propylenea as described in step S8. A layer of Aliphatic Propylene, Glycolethers such as Shrinkage Reducers may then be positioned atop the Carboxylated Propylene as stated in step S10. The admixture formed by the combination of these elements may then be mixed without any reaction forming between the elements for use in producing building materials.

Additional materials such as an air-entrainer may be added to the mixture by first positioning a further barrier layer of at least one of water, liquid wetting agent or gel wetting agent as discussed in step S12. A further barrier layer of at least one of water, liquid wetting agent or gel wetting agent may then be positioned atop the air-entrainer as described in step S14 prior to adding a layer of an aqueous solution of Carboxylated Polyther, Calcium, nitrate and Amines Glycose such as a Water Reducing agent atop the barrier layer as stated in step S16. Barrier layers may then also be positioned between the last layer and a further layer such as Self-compacting agents as discussed in step S18, Shrinkage control agents as stated in step S20 and Water-repellant agents as described in step S22.

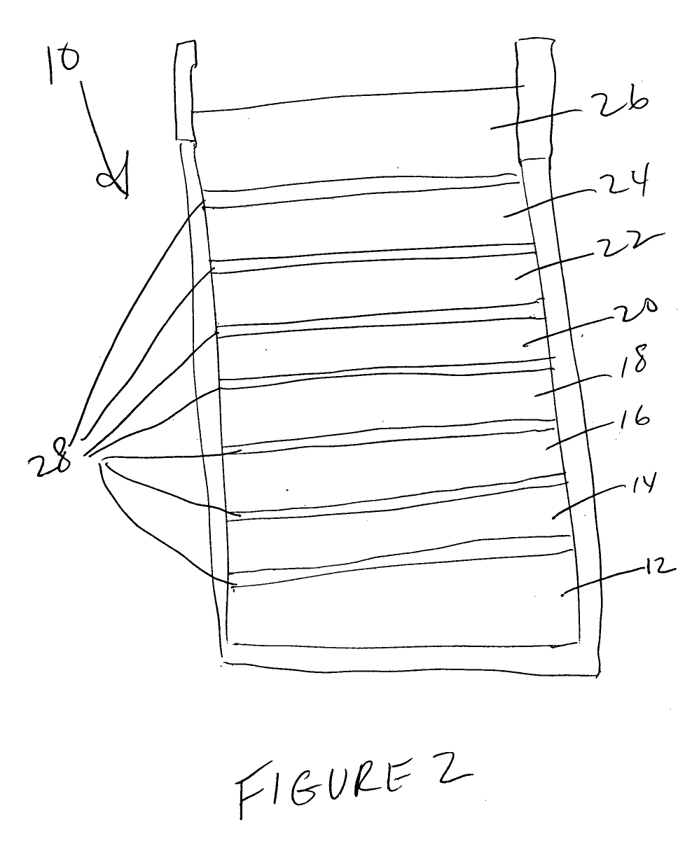

A cross sectional view of a vat including the layered elements is shown in FIG. 2 and indicated generally by the reference numeral 10. As can be seen from this figure, the barrier layers 28 of at least one of water, liquid wetting agent or gel wetting agent separate each element within the admixture thereby reducing or preventing any reactions between the elements. As can be seen from this figure, the admixture is formed with a predetermined amount of Carboxylated Polyther such as a Superplasterizer 12 forming a bottom layer. A layer of Carboxylated Propylene 14 such as a Self consolidator is positioned atop the Carboxylated Polyther 14 with a barrier layer 28 of at least one of water, liquid wetting agent or gel wetting agent therebetween. Another barrier layer 28 of at least one of water, liquid wetting agent or gel wetting agent is then positioned atop the layer of Carboxylated Propylene and a layer of Aliphatic Propylene, Glycolethers 16 such as Shrinkage Reducers are then positioned atop the barrier layer. The admixture formed by the combination of these elements may then be mixed without any reaction forming between the elements for use in producing building materials.

Additional materials such as an air-entrainer 18 may be added to the mixture by first positioning a further barrier layer 28 of at least one of water, liquid wetting agent or gel wetting agent atop the layer of Aliphatic Propylene, Glycolethers 16. A further barrier layer 28 of at least one of water, liquid wetting agent or gel wetting agent may then be positioned atop the air-entrainer and a layer of an aqueous solution of Carboxylated Polyther, Calcium, nitrate and Amines Glycose 20 such as a Water Reducing agent may be positioned atop the barrier layer. Barrier layers may then also be positioned between the last layer and a further layer such as Self-compacting agents 22, Shrinkage control agents 24 and Water-repellant agents 26. The order in which the elements are added is provided as an exemplary order. In practice these elements may be added n any order as long as a layer formed of water or wetting agent is positioned between layers and is able to maintain separation between the layers until mixing to form the admixture.

FIG. 3 is a flow diagram showing the method for producing a building material using the admixture discussed above with reference to FIGS. 1 and 2. In order to produce the building material of the present invention, a desired amount of light weight fillers such as vermiculite is combined with at least one of water and a wetting agent in an amount able to substantially saturate the vermiculite as discussed in step S100. Additionally, microfibers may be added to the vermiculite as desired. A measured amount of cement is then added to the saturated vermiculite and microfibers as stated in step S102. Along with the cement, sand, silica and other elements such as fiber glass or other fibers may be added. The admixture as discussed above is then added to the cement and vermiculite/microfiber combination as described in step S104. At this point, Metakatolin, e.g. a pozzolanie material, may be added to the composition as necessary as discussed in step S106. Structural fiber may then be added as desired as stated in step S108. The metakatolin and structural fiber may be continuously added as indicated by the arrow labeled with the numeral 110 as necessary or to obtain the desired consistency. This entire process is performed within a mixing device and is constantly mixed during the entire process. After addition of the cement it may be necessary to add additional water or wetting agents.

Alternatively, this process may be performed in a static mixer 400 as shown in FIG. 4. As can be seen from this figure, the elements 402 needed to produce the building material are added in the top/funnel 404 of the static mixer 400 and allowed to flow along the tracks 406, 408 therein constantly mixing the elements. Added to the mixer through a pipe 410 positioned thereon are amounts of the inventive admixture, water or wetting agent 414 for saturating the light weight fillers such as vermiculite and wetting the cement. The admixture may be provided either separately or in combination with either the water or wetting agent provided to the cement. The admixture and water or wetting agent are placed in a holding tank pump and supplied to the static mixer 400 under pressure for reacting with the cement to produce a pasty sticky fabric like substance. As the elements 402 of the composition pass through the static mixer 400 they are constantly mixed to form a homogeneous mixture. A pressure 418 is applied to the elements 402 placed in the static mixer 400 thereby force feeding the elements into the static mixer 400 and causing the elements 402 to be pushed therethrough. The pressure 418 may be applied by anything able to create enough pressure such as nitrogen or air. The mixed composition is then cleaned out at the base of the static mixer 400 to remove the pressure inducing agent.

The admixture of the present invention allows lightweight materials to be produced with all the characteristics of pre-cast concrete without any of the drawbacks. Materials produced using the admixture and the method discussed above are lighter in weight, stronger and more resistant to cracking than concrete. The process creates a new material by combining raw materials in a unique fashion. Materials such as concrete, sand, metakatolin, vermiculite, fiber, etc. are combined with the admixture to bond these elements that normally do not bond together to produce a product having a matrix with a compressive flexural and tensile strength that is substantially greater than the compressive flexural and tensile strength of conventional concrete.

Besides producing superior bonding components, the admixture allows the incorporation of high amounts of metakatolin, a Pozzolanic material into the mix. Such has not been possible in the past. Pozzolants are natural or industrially produced materials which react with lime released from the hydration of Portland cement. Through this reaction the addition of metakatolin effectively eliminates free lime and converts the end material into a stable cemetitious product. Pozzolants also reduce the permeability of the cement paste. This helps to prevent the ingress of aggressive substances in the solution which cause effervescence and low permeability results in a durable cemetitious mix which is able to withstand attack by sulfates, acids, freezing and thawing conditions, de-icing salts and seawater. In addition, the light weight fillers such as vermiculite added to the mix not only helps reduce the weight of the end product but also soaks up liquids and water as well. The materials cure slowly and consistently because of the vermiculites which act as a time release in the evaporation of water in the mix. Thus, the cemetitious end product is constantly provided with liquid thereby minimizing the possibility of cracking and strengthening the end product.

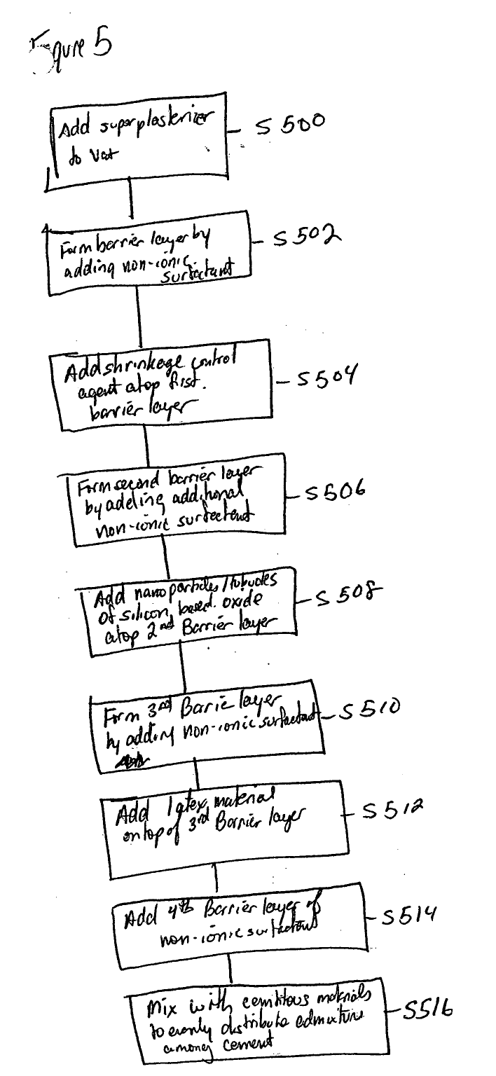

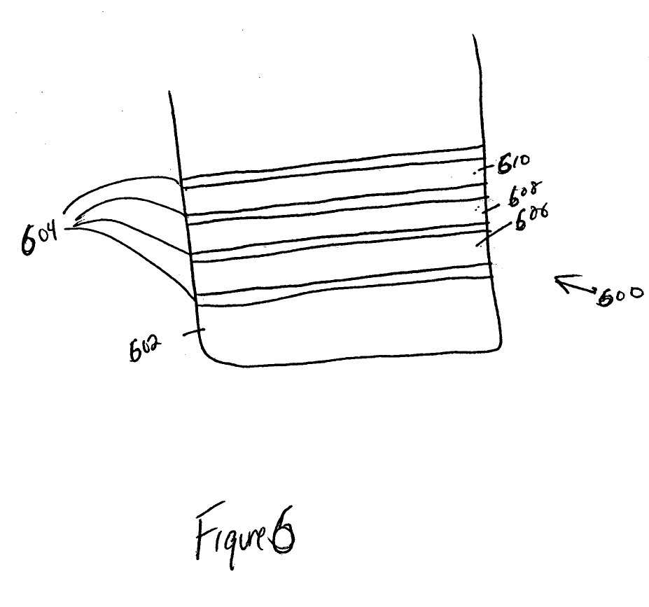

Additionally, the admixture of the present claimed invention can be combined with a second mixture having at least one of nanoparticles and nanotubuoles contained therein to produce a cementious material. The nanoparticles and/or nanotubuoles provide increased strength to the resulting cementious material. Furthermore, the weight of the resulting cementious material is substantially less than conventional cementious material. Alternatively, the building material of the present invention may includes nanoparticles and/or nanotubuoles that are uniformly distributed throughout the mixture during the mixing process as will be discussed hereinafter with specific reference to FIGS. 5 and 6.

FIG. 5 is a flow diagram showing how an alternate embodiment of the admixture is produced. Similarly to FIG. 1, the superplasterizer is added to a vat as shown in step S500. Thereafter, it is important to form a barrier layer as discussed in step S502. However, unlike the admixture produced in FIG. 1, the barrier layer formed in step S502 is formed from a wetting agent that is a non-ionic surfactant having an HLB value between 7-9. Thereafter, as shown in step S504, a predetermined amount of shrinkage control agent is added atop the first barrier layer. The non-ionic surfactant first barrier layer prevents the superplasterizer and the shrinkage control agents for interacting with one another. A second barrier layer is formed by adding a non-ionic surfactant atop the layers of shrinkage control agent and superplasterizer as shown in step S506. A layer of nanoparticle formed from silicon based oxides is then added atop the second barrier layer as shown in step S508. The nanoparticulate silicon based oxides provides an enhanced hardness and increased structural support enhancement to the admixture which later will be combined with cemetitious materials to produce the resultant mixture. A third barrier layer of non-ionic surfactant is added on top of the layer of nonoparticulate material, shrinkage control agent, and superplasterizer as in step S510. Step S512 then requires a layer of latex material be added to the admixture atop the third non-ionic surfactant barrier layer. A final fourth non-ionic surfactant barrier layer is to be added to the top of the layer of latex as required by step S514. This completes the alternate embodiment of the admixture of the present claimed invention. Thereafter, in step S516, the completely layered admixture is combined with the cementitious materials previously identified in order to produce the resultant mixture for use in producing building materials having an increased tensile strength and hardness, as well as structural characteristics which make for a superior building and architectural material.

Alternatively, steps S502, S506, S510 and S514 can include the use of latex as the barrier layer for positioning between the superplasterizer, shrinkage control agents, and nanoparticles. Additionally, the layer of nanoparticles formed from silicon oxide can be interspersed within another layer of the admixture. Specifically, the nanoparticles can be combined with at least one of the latex, superplasterizer and shrinkage control agents of the inventive admixture.

The proportions of each respective component used to form the admixture of the present invention can be varied. However, changing the amounts of each element changes the characteristics of the final product such as weight, strength, durability and hardness. Therefore, the proportions can be altered based on upon the desired characteristics of the product to be produced. This varying proportionality of components to be used with the admixture of the present invention also applies to the resultant mixture with cementitious material as discussed hereinafter. By altering the proportions of the components, the resulting characteristics of the building or architectural material will be changed. Thus, the material can be formed based on the desired resulting characteristics of the building or architectural material.

FIG. 6 is a cross-sectional view of a vat 600 having the alternate embodiment of the admixture of the present invention. A layer of each of superplasterizer 602 is positioned at the base of the vat 600. The vat also includes a layer of shrinkage control agent 608, a layer of nanoparticulate silicon based oxide 610 and layer of latex material 612. Positioned between each of the layers 602, 608, 610, 612 is a barrier layer 604 formed from a non-ionic surfactant. The positioning of the barrier layer is important as it prevents an unwanted mixing of the individual components of the admixture prior to the combination with the cementitous material in the production of the inventive building material. It is important to keep the elements separate and only combine them in the presence of the cementitious material in order to ensure that each respective element is uniformly folded into the mixture when producing the building material. This uniform combination allows for each of the properties possessed by each respective element be applied to the resultant mixture.

Alternatively, the layer of nonparticulate silicon based oxide can be removed and combined with at least the layer of latex material 612 and the layers on non-ionic surfactants 604.

The admixture described in FIGS. 5 and 6 is combinable with cementitious material in the manner described hereinabove with specific reference to FIGS. 3 and 4. The inventive admixture as having the nanoparticulate silicon based oxide, once mixed uniformly with the cementitious materials described above create building or architectural material that has superior strength and hardness associated therewith. The silicon based oxide nanoparticles, which are infused with a predetermined metal at the lattice level, allow for bonding with the cementitious material thereby enhancing the hardness and structural support of the resultant mixture. Furthermore, with the inclusion of the non-ionic surfactant, the weight of the resultant building material is significantly reduced while maintaining the strength thereof.

The admixture of the present invention allows lightweight materials to be produced with all the characteristics of pre-cast concrete without any of the drawbacks. The materials produced using the admixture and the method discussed above is lighter in weight, stronger and more resistant to cracking than concrete. The process creates a new material by combining raw materials in a unique fashion. Materials such as concrete, sand, metakatolin, vermiculite, fiber, etc. are combined with the admixture to bond these elements that normally do not bond together to produce a product having a matrix with a compressive flexural and tensile strength multiples of the compressive flexural and tensile strength of conventional concrete. The blended material formed by the described method using the inventive admixture allows for the creation of new finished products. For example, the blended material can be used to produce a lightweight, thin panel which can be used to cover over foam, metal and/or wood at very low cost and provide a look of a very expensive cut stone, marble, limestone, wood, etc. Thus, having the nanoparticulate silicon based oxide in the resultant mixture, the enhanced scratch resistance possessed by the material is equally as important. By having enhanced scratch resistance, the material is highly resistant from incidental and deliberate contact from other objects which could degrade the building material and adversely affect the structural integrity thereof.

Additionally, the admixture of the present invention allows for viscosity of the material being produced to be varied so to allow for the addition of at least one vermiculite, nanoparticles, nanotubuoles, and fibrous matieral. This viscosity is further augmented by the addition of a viscosity control agent that allows for the viscosity of the composition to be varied in order to accomplish different objectives. Thus, this admixture is useable in many fields including cementitious materials as well plastics.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method for minimizing reactions between a plurality of reactionary chemicals comprising the activities of:
a. adding a first chemical;
b. adding a first barrier layer, the first barrier layer resting atop the first chemical;
c. adding a second chemical, the second chemical resting atop said first barrier layer;
d. adding a second barrier layer, the second barrier layer resting atop the second chemical;
e. adding a further chemical, the further chemical composition resting atop the second barrier layer;
f. mixing the compositions and barrier layers uniformly, thereby evenly distributing each of the first, second and further chemical to form a mixture wherein the chemicals are added in order of decreasing density.

2. The method as recited in claim 1, wherein said adding activities add chemicals to a static mixer.

3. The method as recited in claim 1, further comprising the activity of adding nanoparticles.

4. The method as recited in claim 1, further comprising the activity of adding a casting agent for casting the mixture in to a predetermined form.

5. The method as recited in claim 1, further comprising the activity of adding cementitious material and vermiculite for producing at least one of a building material and architectural material.

6. The method as recited in claim 1, further comprising the activity of adding plastic material and vermiculite for producing at least one of a building material and architectural material

7. The method as recited in claim 1, further comprising the activity of adding rubber material and vermiculite for producing at least one of a building material and architectural material

8. A composition comprising.
a. a first chemical;
b. a second chemical; and
c. at least one barrier layer positioned between said first chemical and said second chemical for preventing interaction therebetween and, upon mixing according to predetermined rules to produce a mixture having each of said first chemical and second chemical uniformly distributed throughout.

9. The composition as recited in claim 8, further comprising a casting agent for allowing said composition to be selectively cast prior to producing the building material.

10. The composition as recited in claim 8, further comprising a third chemical composition including nanoparticles.

11. The composition as recited in claim 8, wherein at least one of said first chemical, said second chemical and said at least one barrier layer further comprises nanoparticles formed integrally therewith.

12. The composition as recited in claim 9, wherein said casting agent further comprises nanoparticles formed integrally therewith.

13. The composition as recited in claim 8, wherein said at least one barrier layer is at least one of water, a surfactant, water and surfactant mixture, and a wetting agent.

14. The composition as recited in claim 8, wherein said composition is selectively combinable with a plurality of raw materials for producing at least one of a substrate and casting material.

15. The composition as recited in claim 14, further comprising at least one of vermiculite, cement, purlite, sand, silica, plastics, rubber, Metakatolin- apozzo-lanie-material, mica, polypropylene, polyethelene, fiber glass and other fibrous materials.

16. The composition as recited in claim 8, wherein said first chemical comprises at least one of Superplasterizer, self-consolidator, shrinkage reducers and air-entrainer.

17. The composition as recited in claim 16, wherein said second chemical comprises at least one of Superplasterizer, self-consolidator, shrinkage reducers and air-entrainer, wherein said first chemical is different than said second chemical.

18. The composition as recited in claim 17, further comprising a third chemical having a respective one of the plurality of barrier layers positioned between said third chemical and said second chemical.

19. The composition as recited in claim 18, wherein said third chemical comprises at least one of Superplasterizer, self-consolidator, shrinkage reducers and air-entrainer, wherein said third chemical is different from each of said first chemical and said second chemical.

20. A composition comprising:
a) At least one of a substrate and casting material; and
b) An admixture, said admixture comprising:
i. Superplasterizer;
ii. self-consolidaton;
iii. shrinkage reducers; and
iv. a plurality of barrier layers, wherein when producing said admixture one of said plurality of barrier layers is provided between each adjacent element of said admixture preventing intermixing between the elements thereby minimizing reactions between said elements and allowing each respective element to maintain properties associated therewith; and
when said admixture is combined with said substrate and mixed to form said composition said admixture is uniformly distributed throughout said composition causing said at least one of substrate and casting material and each element of said admixture to bond to each other.

21. The composition as recited in claim 20, wherein each respective one of said barrier layers is at least one of water, surfactant, a water and surfactant mixture and a wetting agent.

22. The composition as recited in claim 21, wherein said wetting agent is at least one of a liquid wetting agent and gel wetting agent.

23. The composition as recited in claim 20, wherein said superplasterizer is carboxylated polyther.

24. The composition as recited in claim 20, wherein said self-consolidator is carboxylated propylene.

25. The composition as recited in claim 20, wherein said shrinkage reducer is at least one of aliphatic propylene and glycolethers.

26. The composition as recited in claim 20, further comprising a layer of water reduction agent positioned atop a barrier layer.

27. The composition as recited in claim 26, wherein said water reduction agent is an aqueous solution having a predetermined amount of carboxylated polyther, calcium, nitrates, and amines glycose.

28. The composition as recited in claim 20, further comprising a self compacting agent positioned atop a barrier layer.

29. The composition as recited in claim 27, further comprising a predetermined amount of self compacting agent.

30. The composition as recited in claim 20, further comprising a predetermined amount of shrinkage control.

31. The composition as recited in claim 29, further comprising a predetermined amount of shrinkage control agent.

32. The composition as recited in claim 20, further comprising a predetermined amount of water repellant agent.

33. The composition as recited in claim 31, further comprising a predetermined amount of water repellant agent.

34. The composition as recited in claim 20, wherein said admixture further comprises a predetermined amount of nanoparticles.

35. The composition as recited in claim 33, wherein said admixture further comprises a predetermined amount of nanoparticles.

36. The composition as recited in claim 20, wherein said composition comprises a predetermined amount of nanoparticles.

37. The composition as recited in claim 20, wherein said at least one of said substrate and casting material comprises at least one cement, vermiculite, plastic and rubber.

38. The composition as recited in claim 37, wherein said at least one of said substrate and casting material further comprises purlite.

39. The composition as recited in claim 37, wherein said at least one of said substrate and casting material further comprises mica.

40. The composition as recited in claim 37, wherein said at least one of said substrate and casting material further comprises at least one of sand and silica.

41. The composition as recited in claim 37, wherein said at least one of said substrate and casting material further comprises metakatolin.

42. The composition as recited in claim 37, wherein said at least one of said substrate and casting material further comprises Polypropylene microfiber.

43. The composition as recited in claim 37, wherein said at least one of said substrate and casting material further comprises Polypropylene structural fiber.

44. The composition as recited in claim 20, wherein said admixture further comprises at least one of an air-entrainer, viscosity control agent, and a non-ionic surfactant.

45. A method for producing a composition comprising the activities of:
a) Combining a predetermined amount of at least one of a substrate and a casting material with at least one of water and a wetting agent in order to saturate the at least one of the substrate and casting material;
b) combining an admixture with the saturated substrate and casting material, said admixture comprising:
i. superplasterizer;
ii. self-consolidator;
iii. shrinkage reducers; and
iv. a plurality of barrier layers, wherein one of said plurality of barrier layers is provided between each element of said admixture preventing intermixing between the elements thereby allowing each respective element to maintain properties associated therewith;
c) mixing continuously the mixture of at least one of substrate and casting material and admixture; and
d) forming a composition wherein each respective element of the admixture is uniformly distributed throughout the composition causing the elements of the admixture to bond with each of the at least one of substrate and casting material and having properties associated with the elements of the admixture.

46. The method as recited in claim 45, wherein the at least one of the substrate and casting material is at least one of cement, vermiculite, plastic and rubber.

47. The method as recited in claim 45, further comprising the activity of combining at least one of sand, silica and fibrous glass into the mixture.

48. The method as recited in claim 45, further comprising the activity of combining metakatolin into the mixture.

49. The method as recited in claim 45, further comprising the activity of combining microfibrous material into the mixture.

50. The method as recited in claim 45, wherein said method is performed in a static mixer.

51. The method as recited in claim 45, wherein said step of combining the admixture further comprises the activity of combining a predetermined amount of nanoparticles therein.

52. The method as recited in claim 45, further comprising the activity of combining nanoparticles with the mixture.

53. The method as recited in claim 45, wherein said step of combining the admixture further comprises the activity of combining at least one of an air-entrainer, viscosity control agent, and a non-ionic surfactant therein.

54. The method as recited in claim 45, wherein each respective one of said barrier layers is at least one of water, surfactant, a water and surfactant mixture and a wetting agent.
